(19) United States
(12) Patent Application Publication
(10) Pub. No.: US 2012/0096408 A1
(43) Pub. Date: Apr. 19, 2012

(54) SYSTEM AND METHOD FOR ESTABLISHING A COLLABORATIVE WORKSPACE

(75) Inventors: Gregory J. Boss, Saginaw, MI (US); Andrew R. Jones, Round Rock, TX (US); Charles S. Lingafelt, Durham, NC (US); Kevin C. McConnell, Austin, TX (US); John E. Moore, JR., Brownsbsurg, IN (US)

(73) Assignee: INTERNATIONAL BUSINESS MACHINES CORPORATION, Armonk, NY (US)

(21) Appl. No.: 12/905,403

(22) Filed: Oct. 15, 2010

(51) Int. Cl. G06F 3/048

(52) U.S. Cl. 715/843

(57) ABSTRACT

An approach that establishes a collaborative workspace for one or more users based on a predefined context. In one embodiment, there is a collaborative workspace tool that includes a user input component configured to receive one or more user inputs when selecting collaborative workspace content from a plurality of pre-arranged resources displayed on a user interface to include in a collaborative workspace. The collaborative workspace tool further includes a preserving component configured to gather information relating to the selected workspace content, build a workspace object to preserve the selected workspace content and save the workspace object; and a rendering component to build the collaborative workspace on a user device when the workspace object is opened from the user device.

### FIELD OF THE INVENTION

This invention relates generally to collaborative workspaces and more specifically to the establishment, maintenance, and sharing of a collaborative workspace between one or more individuals based on a predefined context.

### BACKGROUND OF THE INVENTION

Sharing of computer-based information has become commonplace with today's technology. In today's workplace, computers and networks are used to increase business productivity. Often, computer users have a need to send and share data or links to data. This information is often put in emails and calendar invitations and, many times, used to drive business meetings and collaboration sessions.

Today, information sharing is typically done manually by copying links and embedding attachments when sending information to other individuals (via emails, calendar invites, etc.) so all participants are working off the same view of the data. The problem with this type of data sharing is that the recipient of the data must click on each of the links or load the various data into a program that supports the data so that the data can be viewed. This process can be cumbersome and time-consuming. Additionally, it is burdensome for the creator of the calendar event or email to “build” all the appropriate attachments and/or links to the data required to run a meeting or collaboration session. A need exists to provide an efficient way to have participants access multiple resources, such as applications and data, within a computing environment system.

### SUMMARY OF THE INVENTION

This disclosure describes a system and method for establishing a collaborative workspace for a plurality of users through the creation of a collaborative workspace object that ensures everyone has the same resources open and available to them in the order/configuration needed. By using this system, the collaborative experience of the participants is greatly enhanced as all participants see the same set of resources in a common layout.

In one embodiment, there is a method for establishing a collaborative workspace for a plurality of users. In this embodiment, the method comprises: receiving one or more user selections of workspace content from a plurality of pre-arranged resources displayed on a user interface to include in a collaborative workspace; gathering information relating to the selected collaborative workspace content; building a collaborative workspace object from the gathered information to preserve the selected collaborative workspace content; saving the collaborative workspace object; and building the collaborative workspace on a user device when the collaborative workspace object is opened from the user device.

In a second embodiment, there is a computer system for establishing a collaborative workspace environment for a plurality of users. In this embodiment, the system comprises: at least one processing unit and memory operably associated with the at least one processing unit. A collaborative workspace tool is storable in memory and executable by the at least one processing unit. The collaborative workspace tool comprises: a user input component configured to receive one or more user inputs when selecting collaborative workspace content from a plurality of pre-arranged resources displayed on a user interface to include in a collaborative workspace; a preserving component configured to gather information relating to the selected collaborative workspace content and build a collaborative workspace object from the gathered information to preserve the selected collaborative workspace content and save the collaborative workspace object; and a rendering component to build the collaborative workspace on a user device when the collaborative workspace object is opened from the user device.

In a third embodiment, there is a computer-readable medium storing computer instructions which, when executed, enables a computer system to establish a collaborative workspace for a plurality of users, the computer readable medium comprising: program code for causing a computer system to: receive one or more user inputs from a user interface when selecting collaborative workspace content from a plurality of pre-arranged resources displayed on a user interface to include in a collaborative workspace; gather information relating to the selected collaborative workspace content; build a collaborative workspace object from the gathered information to preserve the selected collaborative workspace content; save the collaborative workspace object; and build the collaborative workspace on a user device when the collaborative workspace object is opened from the user device.

In a fourth embodiment, there exists a method for deploying a system for establishing a collaborative workspace for a plurality of users. In this embodiment, a computer infrastructure is provided and is operable to: receive one or more user inputs from a user interface when selecting collaborative workspace content from a plurality of pre-arranged resources displayed on a user interface to include in a collaborative workspace; gather information relating to the selected collaborative workspace content; build a collaborative workspace object from the gathered information to preserve the selected collaborative workspace content; save the collaborative workspace object; and build the collaborative workspace on a user device when the collaborative workspace object is opened from the user device.

### BRIEF DESCRIPTION OF THE DRAWINGS

These and other features of this invention will be more readily understood from the following detailed description of the various aspects of the invention taken in conjunction with the accompanying drawings in which:

FIG. 1 illustrates a computerized implementation 100 of the present invention.

FIG. 2 shows a schematic of an exemplary collaborative environment in which elements of the present invention may operate;

FIG. 3 shows an illustrative example of available resources presented to a collaborative workspace creator;

FIG. 4 shows an exemplary user interface for collaborative workspace content selection from available resources depicted in FIG. 3;

FIG. 5 shows an illustrative example of XML source code generated from the selections made in FIG. 4;

FIG. 6 shows a collaborative workspace tool that operates in the environment shown in FIG. 1; and

FIG. 7 shows an flow diagram of a process for establishing a collaborative workspace to one or more individuals;

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to establishing a collaborative workspace for a plurality of users through the creation of a collaborative workspace object that ensures everyone has the same resources open and available to them in the order/configuration needed. Specifically, a collaborative workspace tool is used to select a plurality of resources to include in a collaborative workspace, save the selected workspace content as a collaborative workspace object, and render the selected workspace content on a user device when the collaborative workspace object is invoked by the user device.

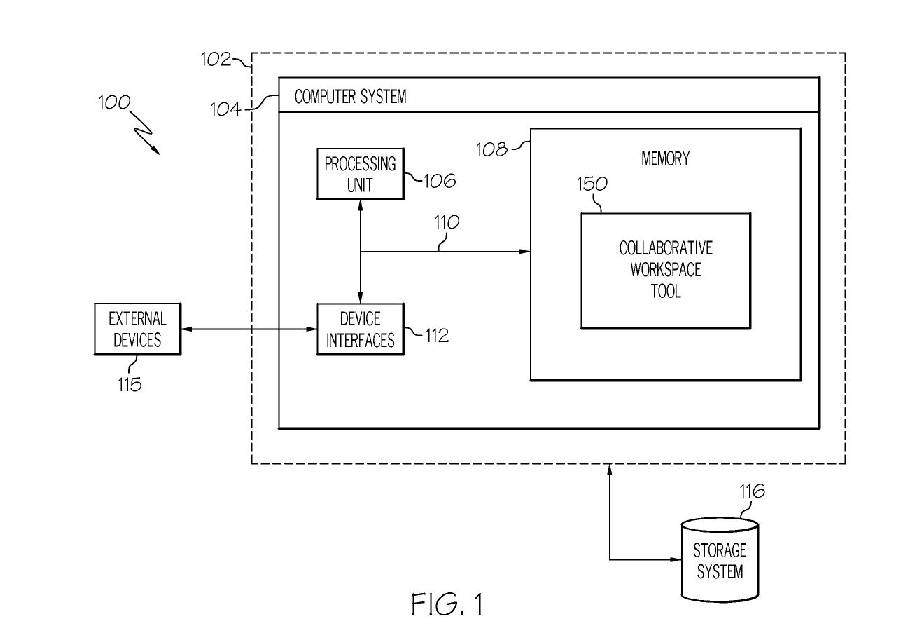

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for establishing a collaborative workspace process. It should be understood that any other computers implemented under the present invention may have different components/software, but will perform similar functions. As shown, computer system 104 includes a processing unit 106, memory 108 for storing a collaborative workspace tool 150, a bus 110, and device interfaces 112.

Processing unit 106 collects and routes signals representing outputs from external devices 115 (e.g., a keyboard, a pointing device, a display, a graphical user interface, etc.) to collaborative tool 150. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG).)

In general, processing unit 106 executes computer program code, such as program code for operating collaborative workspace tool 150, which is stored in memory 108 and/or storage system 116. While executing computer program code, processing unit 106 can read and/or write data to/from memory 108 and storage system 116. Storage system 116 can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

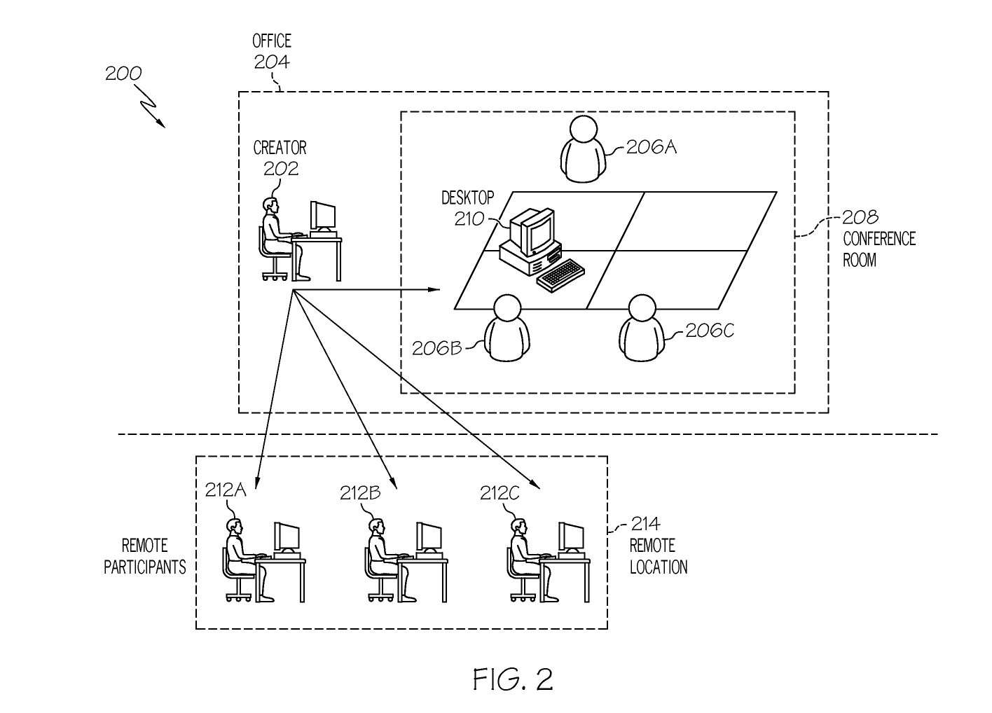

Many companies today have employees that work exclusively or part-time from an office at home. Also, many workers are required to travel when conducting business. There are times when meetings need to be held that require input from one or more remote workers. Referring now to FIG. 2, a schematic of an exemplary collaborative environment in which elements of the present invention may operate is depicted. FIG. 2 shows collaborative environment 200 including office 204 and remote location 214. Creator 202 creates a collaborative workspace to be used in a meeting with six other participants (users 206A, 206B, 206C, 212A, 212B, 212C).

Creator 202 opens a plurality of resources (i.e., data and/or applications) on his desktop and arranges the resources on the display device in a layout conducive to the meeting. The layout of the resources is important because the chosen layout is how the other meeting participants will view the content when the collaborative workspace is rendered. For example, a person speaking during the meeting might reference “the window on the far left.” Each participant will know the window being referenced because the workspace layout is identical for each participant.

Creator 202 selects resources to be included in the collaborative workspace content from the available resources opened on his desktop. The resources deemed by creator 202 to be necessary for the meeting, whether all or a subset of available resources displayed, are selected. Creator 202 saves the workspace by clicking on a save button. The system gathers information related to the selected collaborative workspace content necessary to render the collaborative workspace, builds a workspace object using the gathered information, and saves the workspace object.

Creator 202 makes the workspace object available to the other meeting participants (users 206A, 206B, 206C, 212A, 212B, 212C). In this example, the workspace object may be copied to the LAN, making the workspace object accessible to participants inside the office (206A, 206B, 206C). For those individuals participating from remote location 214 (users 212A, 212B, 212C), the workspace object may be emailed to each of them by creator 202. When the collaborative workspace object is opened by a participant, the workspace is built on the participant's desktop. The meeting is greatly enhanced and more productive as all meeting participants see the same set of resources in a common layout.

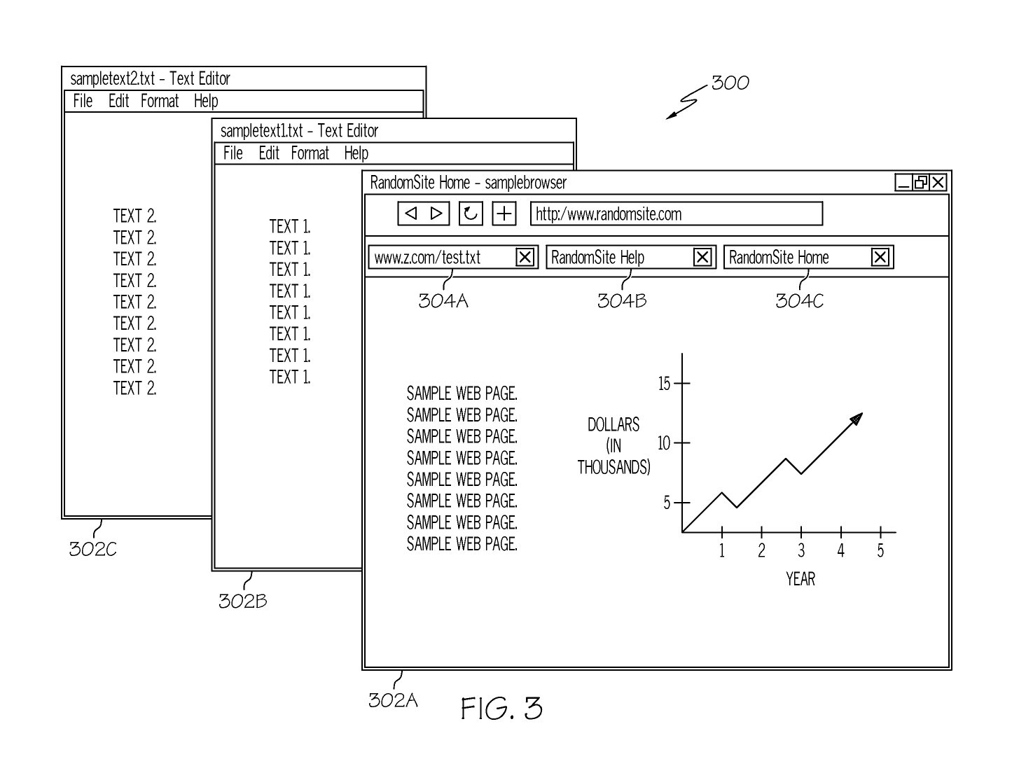

FIG. 3 depicts exemplary creator desktop 300 including three windows (302A, 302B, 302C). Window 302A is an internet browser having three browser tabs (304A, 304B, 304C). Each browser tab functions like a browser window to display distinct content. Browser tab 304C is the tab selected to be displayed. Two text documents (302B and 302C) are also depicted. Three browser tabs (304A, 304B, 304C) of window 302A are each available resources for the collaborative workspace. Furthermore, the text documents being edited in windows 302B and 302C are resources available for selection.

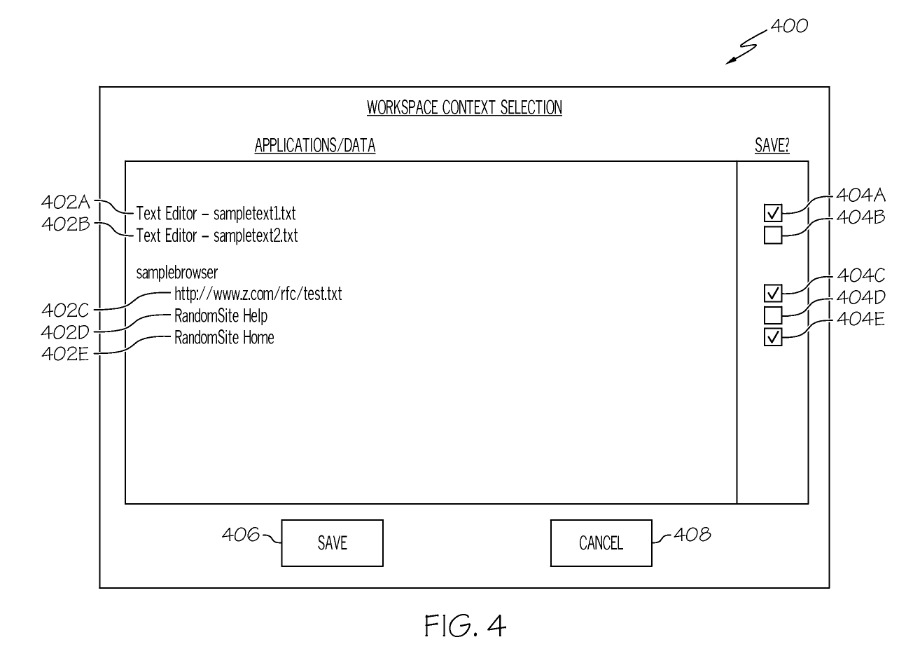

FIG. 4 shows an exemplary user interface for collaborative workspace content selection from the available resources depicted in FIG. 3. The three browser tabs (304A, 304B, 304C) of browser 302A, as well as the two text documents (302B, 302C) are listed as resources available in the selection window (402A-402E). Checkboxes 404A-404E are displayed to the right of the interface. In computing, a checkbox is a graphical user interface element that permits the user to make multiple selections from a number of options. Save button 406 and cancel button 408 are at the bottom of the screen.

As shown, two browser tabs and one text document are selected (402A, 404C, 402E) as content to be included in a collaborative workspace. Information relating to the selected collaborative workspace content is saved as an object. Information may include: application name, data file (e.g., document being edited), window information (e.g. coordinates of window, window size, etc.), and external data source links (e.g. URLs of selected browser tabs selected). This object is a binary representation of the above content. In one embodiment, the object is stored as XML or Extensible Markup Language.

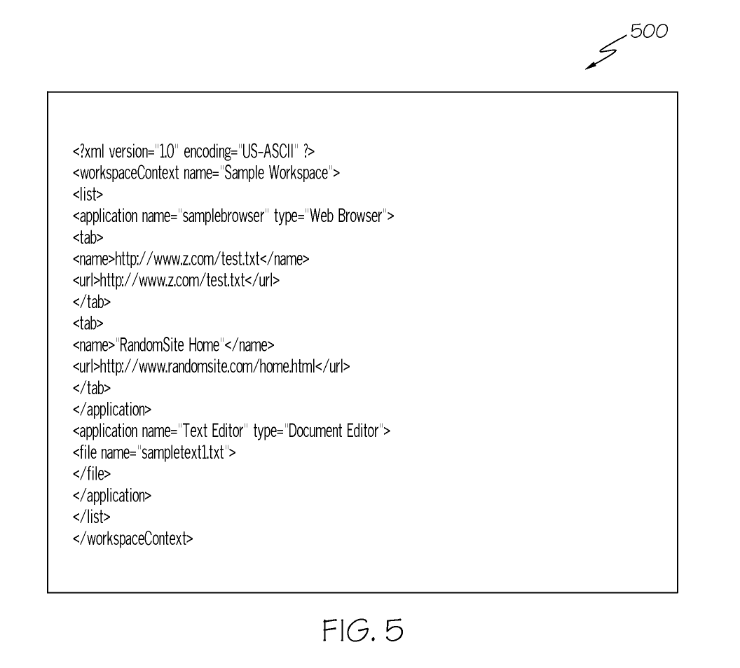

FIG. 5 shows an illustrative example of XML code 500 generated from the selections made in FIG. 4. XML is a generic format intended for maximum flexibility to provide information in a wide variety of structural formats. A variety of XML specifications exist for different applications. The XML depicted is not a complete illustration, as other data as described above (e.g. window size, window position, etc.) have been omitted.

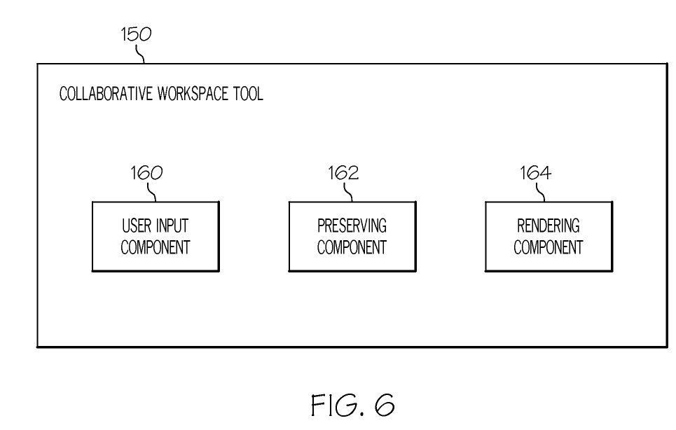

FIG. 6 shows a more detailed view of an exemplary collaborative workspace tool 150 shown in FIG. 1. Collaborative workspace tool 150 comprises user input component 160, preserving component 162 and rendering component 164. The collaborative workspace tool includes a user input component that receives one or more user inputs selecting collaborative workspace content from a plurality of pre-arranged resources displayed on a user interface to include in a collaborative workspace. Referring back to FIG. 4, user input component receives user selections to checkboxes 404A, 404C, and 404E. User input component also receives the user click to save button 406.

Preserving component 162 gathers information relating to selected collaborative workspace content, builds a workspace object using the gathered information to preserve the collaborative workspace content, and stores the workspace object. Rendering component 164 presents the collaborative workspace on a user device when the workspace object is opened from the user device.

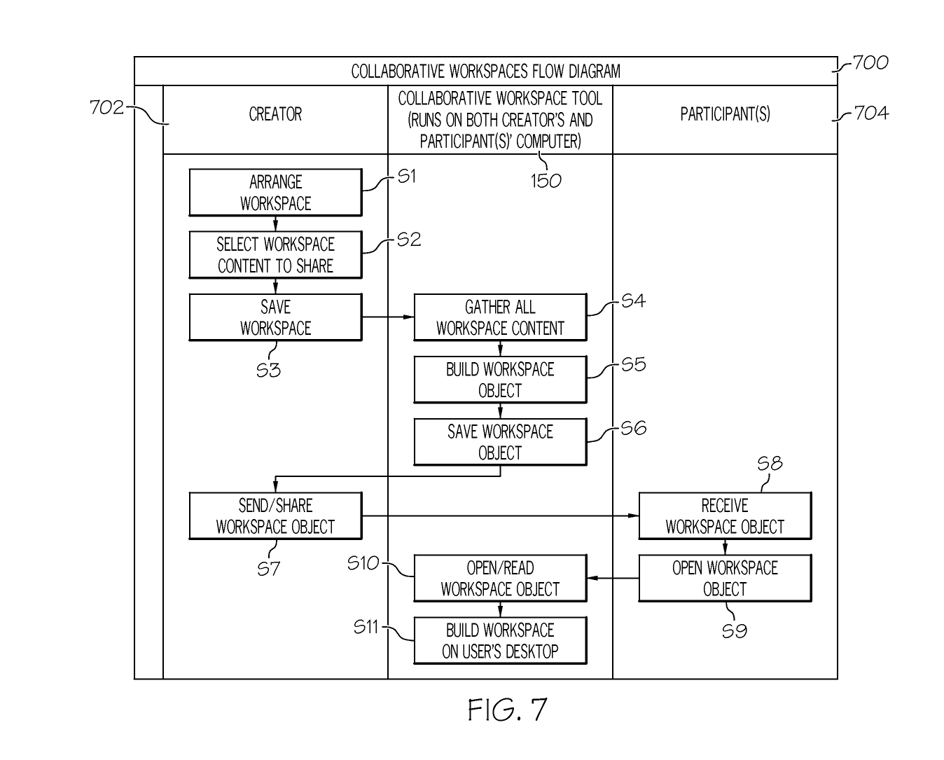

Referring now to FIG. 7, a collaborative workspace process flow 700 for establishing a collaborative workspace to one or more individuals will be described in further detail. As shown, the creator 702 arranges his workspace for the specific context he wants to save (step S1). The content may include a set of documents, applications, etc., that represent the workspace he uses when working on this particular business process or topic. For example, as illustrated in FIG. 3, the workspace is what this user uses when working on a specific topic. The workspace consists of a browser with three tabs which are URLs (uniform resource locators) to related information to the topic and two text documents. The examples of resources are only illustrative and are not limiting. Furthermore, the number of resources shown in FIG. 3 is only for illustration purposes and those skilled in the art will recognize that there may be many more resources a typical desktop, or even only resource on a desktop.

Creator 702 selects workspace content to share (step S2). In one embodiment, creator 702 uses a user interface as shown in FIG. 4 to select content from the running applications/data on the workspace that should be part of the saved context. Alternatively, the selection could be an interactive tool that has the creator click (or right click) on windows/tabs to add to the context. Creator 720 clicks to save the selected content to a workspace object (step S3).

The system gathers relevant data for the preserved content and creates a collaborative workspace object representing the workspace (steps S4 and S5). The data gathered includes information for each resource selected in step S2 and S3. Information may include: application name, embedded application data file (e.g., document being edited), application window information (e.g. coordinates of window, window size, etc.), external data source links (e.g. URLs of selected browser tabs selected, databases, etc.). Other examples may include: source code file stored in a common data repository or instant message chat. The examples of relevant data gathered when preserving content are only illustrative and are not limiting. The content information is saved as an object (step S6). The object is a binary representation of the above content information.

Creator 702 shares the context object with other participant(s) 704. The workspace object saved in step S6 can be attached to emails, calendar invitations, and/or saved in a common file repository where creator 702 or participant(s) 704 can access (step S8).

The participant opens the collaborative workspace system and specifies the shared workspace object (step S9). The collaborative workspace tool loads the shared object (step S10) and builds the workspace (step S11). The system reads the object data and, using known methods, starts the associated applications with the associated links or embedded data (for example, executes command lines to start the sample Internet browser by passing it the two URLs for the tabs selected in FIG. 4).

“Associated applications,” mentioned above, refers to the current mechanisms in operating systems to associate a file type with one or more applications. The application typically registers with the operating system (OS) to handle certain file types (usually denoted by extensions). In addition, in the sample XML depicted in FIG. 5, the application is specified. If the application in the XML code doesn't exist or there isn't an associated application for the data type in the OS, the normal OS behavior could occur. Today, in Microsoft Windows operating systems, a dialog opens and the user is asked to select the application to open the data with or do a web services search for an application to use. Windows is a registered trademark of Microsoft Corporation in the United States and other countries.

It will be appreciated that collaborative workspace flow 700 of FIG. 7 represents one possible implementation of a process flow for providing a collaborative workspace to a plurality of users, and that other process flows are possible within the scope of the invention. Collaborative workspace flow 700 illustrates the architecture, functionality, and operation of possible implementations of systems, methods and computer program products according to various embodiments of the present invention. In this regard, each portion of the flowchart may represent a module, segment, or portion of code, which comprises one or more executable instructions for implementing the specified logical function(s). It will also be noted that each block of the flowchart illustration can be implemented by special purpose hardware-based systems that perform the specified functions or acts.

The present invention is useful without the collaborative aspect of the scenario described above. Individuals can use the system to save workspaces and reopen them as the need arises. For example, if a user has multiple roles, he can save workspaces for each role and open the required workspace at any given time. Workspace objects can be saved in a protected shared space (e.g. shared file system, cloud, etc.), allowing the user to use any computer to load the workspace (for example, a work system and a home system).

In another embodiment, a collaborative workspace collaborative workspace object is saved in a protected shared space (e.g., shared file system, cloud, etc.) incrementally to allow for “go-back-in” recovery techniques for the collaboration space. If subsequent changes are made to any content saved in the collaborative workspace, a delta of the collaborative workspace is saved. For example, the workspace object is saved each day. Referring back to FIGS. 3-5, on day 1, the file ‘sampletext1.txt’ is saved as part of the collaborative workspace. Version 1 of the collaborative workspace is saved as an object. Later on day 1, the file ‘sampletext1.txt’ is modified by a user having access to the file. On day 2, either a delta of the desktop changes is saved or a new version of the XML code is created. By saving versions of the desktop daily, a user can go back to previous version if needed.

In another embodiment of the present invention, the creator of the collaboration space requires the consumer of the space to provide a security credential prior to enabling the access to one or more parts of the collaboration space. For example, the consumer must type in a password to be able to access the documents in the collaborative workspace.

In yet another embodiment of the present invention, collaborative workspace tool 150 verifies the collaborative workspace object is being opened on a user device that meets minimum standards (e.g., all software patching is up to date, a set of security agents are operating correctly, etc.). If the user device does not meet minimum standards, the collaborative workspace object will not open.

The present invention provides an approach for providing a collaborative workspace to one or more individuals. In particular, the present invention includes a collaborative workspace tool comprising: a user input component configured to receive one or more user inputs selecting collaborative workspace content from a plurality of pre-arranged resources displayed on a user interface to include in a collaborative workspace; a preserving component configured to build a workspace object to preserve the collaborative workspace content and save the collaborative workspace object; and a rendering component to build the collaborative workspace on a user device when the workspace object is opened from the user device. This provides significant business benefits by allowing collaboration session participants the ability to see the same set of resources in a common layout.

Further, it can be appreciated that the methodologies disclosed herein can be used within a computer system to provide a collaborative workspace. In this case, collaborative workspace tool 150 can be provided, and one or more systems for performing the processes described in the invention can be obtained and deployed to computer infrastructure 102. To this extent, the deployment can comprise one or more of: (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on, that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for establishing a collaborative workspace for one or more users. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for establishing a collaborative workspace for a plurality of user devices, comprising:
receiving one or more user selections of workspace content from a plurality of pre-arranged resources displayed on a user interface to include in a collaborative workspace;
gathering information relating to the selected collaborative workspace content;
building a collaborative workspace object from the gathered information to preserve the selected collaborative workspace content;
saving the collaborative workspace object; and
building the collaborative workspace on a user device when the collaborative workspace object is opened from the user device.

2. The method according to claim 1, wherein the selection action comprises any of selecting a radio button associated with a resource, selecting a checkbox associated with a resource, selecting a drop-down menu item associated with a resource, and right-clicking on a resource.

3. The method according to claim 1, wherein the collaborative workspace object is saved as an Extensible Markup Language (XML) file.

4. The method according to claim 1, wherein gathering information relating to the selected collaborative workspace content includes location information corresponding to the location of the resource as displayed on the user interface and building the collaborative workspace on a user device includes displaying each resource based on the location information gathered.

5. The method according to claim 1, further comprising requesting a password, receiving a password, and allowing access to the collaborative workspace object only if the password matches predetermined criteria.

6. The method according to claim 1, wherein building the collaborative workspace on a user device only when the user device meets predefined criteria.

7. A computer system for providing a collaborative workspace to a plurality of user devices, comprising:
at least one processing unit;
memory operably associated with the at least one processing unit; and
a collaboration tool storable in memory and executable by the at least one processing unit, the collaborative workspace tool comprising:
a user input component for receiving one or more user selections of workspace content from a plurality of pre-arranged resources displayed on a user interface to include in a collaborative workspace;
a preserving component for gathering information relating to the selected collaborative workspace content, building a collaborative workspace object from the gathered information to preserve the selected collaborative workspace content and saving the collaborative workspace object; and
a rendering component for building the collaborative workspace on a user device when the collaborative workspace object is opened from the user device.

8. The computer system according to claim 7, the user input component configured to receive one or more user selections of workspace content comprising any of selecting a radio button associated with a resource, selecting a checkbox associated with a resource, selecting a drop-down menu item associated with a resource, and right-clicking on a resource.

9. The computer system according to claim 7, the preserving component configured to save the collaborative workspace object as an Extensible Markup Language (XML) file.

10. The computer system according to claim 7, the preserving component configured to gather location information corresponding to the location of the resource as displayed on the user interface and the rendering component configured to display each resource based on the location information.

11. The computer system according to claim 7, the user input component configured to request a password, receive a password, and allowing access to the collaborative workspace object only if the password matches predetermined criteria.

12. The computer system according to claim 7, the rendering component configured to build the collaborative workspace on a user device only when the user device meets predefined criteria.

13. A computer-readable medium storing computer instructions which, when executed, enables a computer system to provide a collaborative workspace to a plurality of user devices, the computer instructions comprising:
receiving one or more user selections of workspace content from a plurality of pre-arranged resources displayed on a user interface to include in a collaborative workspace;
gathering information relating to the selected collaborative workspace content;
building a collaborative workspace object from the gathered information to preserve the selected collaborative workspace content;
saving the collaborative workspace object; and
building the collaborative workspace on a user device when the collaborative workspace object is opened from the user device.

14. The computer-readable medium according to claim 13, wherein the selection action comprises any one of selecting a radio button associated with a resource, selecting a checkbox associated with a resource, selecting a drop-down menu item associated with a resource, and right-clicking on a resource.

15. The computer-readable medium according to claim 13, wherein the collaborative workspace object is saved as an Extensible Markup Language (XML) file.

16. The computer-readable medium according to claim 13, wherein gathering information relating to the selected collaborative workspace content includes location information corresponding to the location of the resource as displayed on the user interface and building the collaborative workspace on a user device includes displaying each resource based on the location information gathered.

17. The computer-readable medium according to claim 13, further comprising requesting a password, receiving a password, and allowing access to the collaborative workspace object only if the password matches predetermined criteria.

18. The computer-readable medium according to claim 13, wherein building the collaborative workspace on a user device only when the user device meets predefined criteria.

19. A method for deploying a collaborative workspace tool for use in a computer system that provides a collaborative workspace to a plurality of user devices, the method comprising:
providing a computer infrastructure operable to:
receive one or more user selections of workspace content from a plurality of pre-arranged resources displayed on a user interface to include in a collaborative workspace;
gather information relating to the selected collaborative workspace content;
build a collaborative workspace object from the gathered information to preserve the selected collaborative workspace content;
save the collaborative workspace object; and
build the collaborative workspace on a user device when the collaborative workspace object is opened from the user device.

20. The computer infrastructure according to claim 19, wherein the selection action comprises any one of selecting a radio button associated with a resource, selecting a checkbox associated with a resource, selecting a drop-down menu item associated with a resource, and right-clicking on a resource.
